(19) United States
(12) Patent Application Publication
(10) Pub. No.: US 2004/0207579 A1
(43) Pub. Date: Oct. 21, 2004

(54) Display device

(76) Inventor: Shoichiro Matsumoto, Ogaki-shi (JP)

Correspondence Address: Michael A. Cantor, Esq., CANTOR COLBURN LLP, 55 Griffin Road South, Bloomfield, CT, 06002, US

(21) Appl. No.: 10/813,800

(22) Filed: Mar. 30, 2004

(30) Foreign Application Priority Data
Apr. 17, 2003 (JP) 2003-113369
Sep. 30, 2003 (JP) 2003-342666
Mar. 25, 2004 (JP) 2004-88495

(51) Int. Cl. G09G 3/30

(52) U.S. Cl. 345/76

(57) ABSTRACT

Two video data processing circuits are used to alternately capture and store a video signal so as to generate an output to a data line during one horizontal line period. With this arrangement, a video signal can drive current driven pixel circuits provided in the respective pixels.

### BACKGROUND OF THE INVENTION

1. Field of the Invention

The present invention relates to a display device in which display is achieved by supplying an electric current video signal to pixels arranged in a matrix such that a current corresponding to the current video signal is made to flow in an emissive element.

2. Description of the Related Art

Electroluminescence (hereinafter referred to as “EL”) display devices including self-emissive EL elements as the emissive element in each pixel are advantageous in that the display device is self-emissive, and that power consumption is small. EL display devices have therefore gained attention as potential replacements for liquid crystal displays (LCD) and CRTs.

Particularly when using an active matrix type EL display circuit in which a switching element such as a thin film transistor (TFT) is provided in each pixel to individually control each EL element, high definition display is possible.

In an active matrix type EL display circuit, a plurality of gate lines extend along a row direction on a substrate, while a plurality of data lines and power lines extend along a column direction. Each pixel includes an organic EL element, a selection TFT, a drive TFT, and a storage capacitor. By selecting a corresponding gate line, the selection TFT is turned on to allow a data voltage (voltage video signal) of a data line to be charged into the storage capacitor. The drive TFT is turned on by the charged voltage to allow power from a power line to be supplied to the organic EL element.

Japanese Patent Laid-Open Publication No. 2001-147659 discloses a circuit in which two TFTs each having a p channel are additionally provided in each pixel as control transistors, and a data current (current video signal) corresponding to a display data is made to flow in a data line.

In other words, in the circuit of JP Laid-Open Publication No. 2001-147659, a current video signal is supplied in a data line to apply the current video signal to a current-to-voltage conversion TFT, which in turn sets a gate voltage of a drive TFT.

In this circuit, the gate voltage of the drive TFT can be set in accordance with the current flowing in the data line. According to this arrangement, a current for driving an EL element can be controlled more precisely compared to when a voltage signal is supplied to a data line. Further, when a current-to-voltage conversion TFT is shared among a plurality of pixels, the number of required elements can be reduced.

However, according to the circuit of JP Laid-Open Publication No. 2001-147659, a current video signal must be supplied to each pixel from outside, and this requires a highly precise current-generating IC. Consequently, a current-generating IC for this purpose must be specially designed. Further, while basic structures such as the drive circuit of an LCD can be adopted in a conventional voltage drive type EL display circuit without making many changes, such basic structures must be separately designed for a current driven display device.

### SUMMARY OF THE INVENTION

The present invention relates to a display device which performs an operation for receiving a voltage video signal supplied from outside while employing current-driven pixel circuits.

According to the present invention, a voltage-to-current converter is provided for converting a voltage signal into a current signal to be supplied to a data line. Accordingly, the device can generate a display corresponding to a normal, externally-supplied video signal, and it is possible to use a current driven pixel circuit without requiring that a special current-generating IC be provided outside the pixel.

### BRIEF DESCRIPTION OF THE DRAWINGS

FIG. 1 shows a configuration according to an embodiment of the present invention.

FIG. 2 shows an example pixel circuit configuration.

FIG. 3 shows the circuit of FIG. 1 in further detail.

FIG. 4 shows waveforms of various signals in the circuit of FIG. 3.

FIG. 5 illustrates a circuit structure for generating DSA and DSB.

FIG. 6 shows waveforms of various signals in the circuit of FIG. 5.

FIG. 7 shows the configuration of the present embodiment in further detail.

FIG. 8 shows an example pixel circuit configuration.

FIG. 9 shows waveforms of various signals in the circuit of FIG. 8.

FIG. 10 is a diagram for explaining determination of voltage Vope.

FIG. 11 shows a pixel circuit configuration according to another example.

FIG. 12 shows a configuration used when employing the pixel circuit of FIG. 11.

### DESCRIPTION OF THE PREFERRED EMBODIMENTS

Preferred embodiments of the present invention will next be described referring to the drawings.

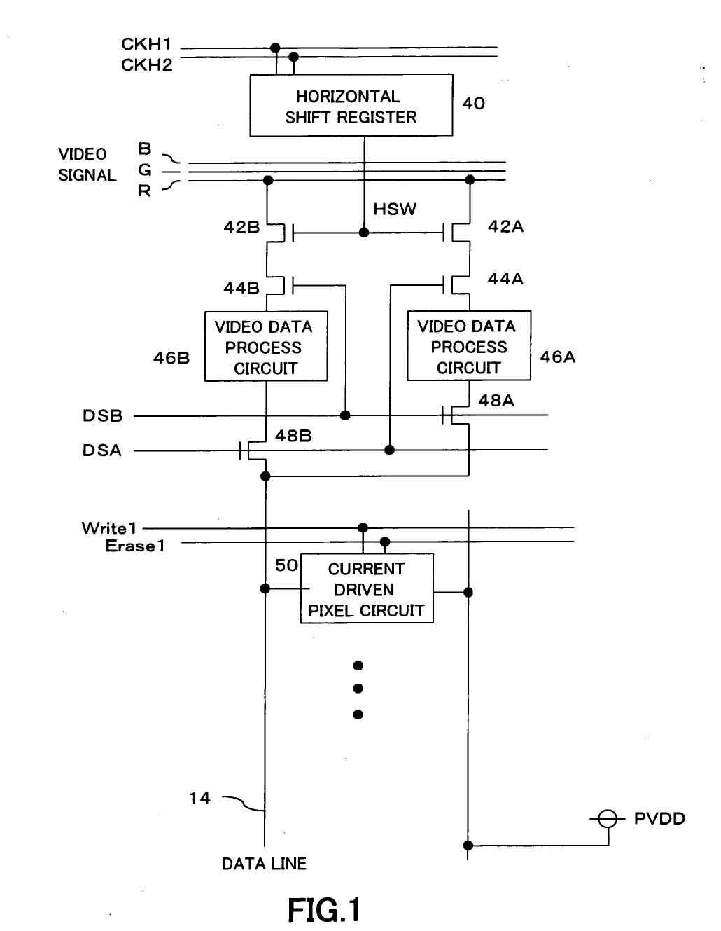

FIG. 1 shows a configuration according to an embodiment of the present invention. An output of a horizontal shift register 40 is connected to the gates of a pair of n-channel TFTs 42A, 42B. The drains of TFTs 42A, 42B are connected to a video signal line (R signal line in this example). The sources of TFTs 42A, 42B are connected to the drains of n-channel TFTs 44A, 44B. The sources of these TFTs 44A, 44B are connected to video data processing circuits 46A, 46B, respectively. Further, the gates of TFTs 44A, 44B receive input of data selection signals DSA, DSB, respectively.

The video data processing circuits 46A, 46B are provided corresponding to each column. Each of the video data processing circuits 46A, 46B stores an input voltage video signal (signal indicating an emissive luminance of a pixel) for corresponding pixels, converts the stored video signal into a current signal, and outputs the converted signal. Because FIG. 1 simply illustrates a pair of video data processing circuits 46A, 46B corresponding to one column in one line only, each of the video data processing circuits 46A, 46B stores data for one pixel and output during one line period the data converted into a current. Two video data processing circuits 46A, 46B are provided to enable the following operation. Video data for one line is input into one of the video data processing circuits 46A, 46B, which subsequently outputs, during the next one line period, a current corresponding to the stored data. During this outputting period, the other of the video data processing circuits 46A, 46B stores data for the next line.

The outputs of the video data processing circuits 46A, 46B are connected to the drains of n-channel TFTs 48A, 48B. The gates of these TFTs 48A, 48B receive input of selection signals DSA, DSB, respectively. The sources of TFTs 48A, 48B are connected to a data line 14 for the corresponding column. Accordingly, when TFT 44A is turned on, TFT 48B is turned on to supply an output from the video data processing circuit 46B to the data line 14. On the other hand, when TFT 44B is turned on, TFT 48A is turned on to supply an output from the video data processing circuit 46A to the data line 14.

Using this arrangement, after data for one line is written by a video signal for one line, the written data is output during the subsequent one line period. This process is sequentially repeated.

The data line 14 is connected to current driven pixel circuits 50. These pixel circuits are sequentially selected and driven by a gate line. Because a current driven pixel circuit 50 is used in the present embodiment, each gate line comprises two lines, a Write line and an Erase line.

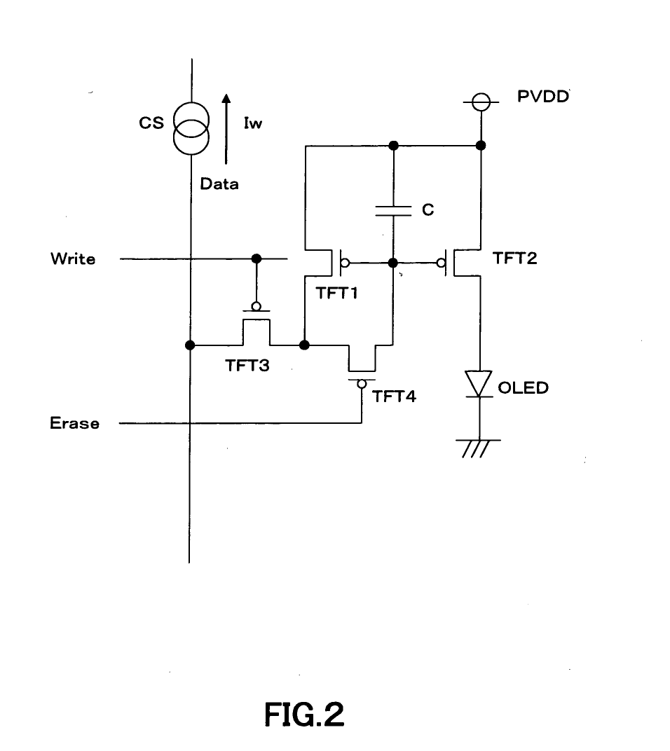

An example configuration of each pixel circuit 50 is next described referring to FIG. 2. The gate of a p-channel TFT (selection TFT) 3 is connected to the gate line Write. One terminal of this TFT 3 is connected to the data line Data which supplies a data current Iw from a current source CS (which corresponds to the video data processing circuit 46). The other terminal of TFT 3 is connected to one terminal of p-channel TFT 1 and one terminal of p-channel TFT 4. TFT 1 has the other terminal connected to a power line PVDD, and the gate connected to the gate of p-channel TFT 2 for driving an organic EL element OLED. TFT 4 has the other terminal connected to the gates of TFT 1 and TFT 2. The gates of TFT 1 and TFT 2 are connected to the power line PVDD via an auxiliary capacitor C. The gate of TFT 4 is connected to the gate line Erase.

In the above-described configuration, when Write is set to L level to turn on TFT 3, Erase is also at L level, turning on TFT 4. At this point, current Iw corresponding to a data is applied to data line Data. As a result, an electrical connection results between the gate and the source of TFT 1, and current Iw flows in TFT 1 and TFT 3. Consequently, current Iw is converted into a voltage, and this voltage is set in the gates of TFTs 1, 2. After TFTs 3, 4 are turned off, a current corresponding to current Iw continues to flow in TFT 2 because the gate voltage of TFT 2 is maintained by the auxiliary capacitor C. This current allows the organic EL element (OLED) to emit light. Subsequently, by setting Erase to L level, TFT 4 is turned on to increases the gate voltage of TFT 1. This causes the auxiliary capacitor C to be discharged, thereby erasing the data and turning off TFTs 1 and 2.

In this circuit, when a current flows in TFT 1, a corresponding current flows in TFT 2 which constitutes a current mirror with respect to TFT 1. In this state, the gate voltage of TFTs 1, 2 is determined and held by the auxiliary capacitor C. This voltage determines the amount of current that flows in TFT 2.

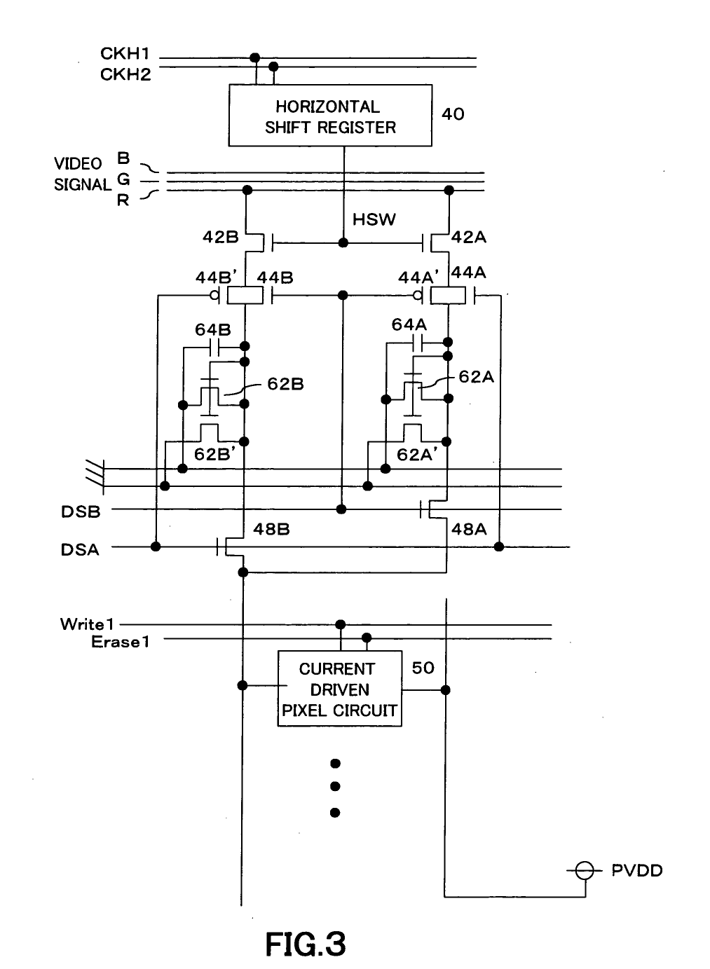

FIG. 3 shows the internal configuration of the video data processing circuits 46A, 46B. Because the video data processing circuits 46A, 46B have basically identical circuit structures, the subscripts A and B are omitted in the following explanation.

Each video data processing circuit 46 comprises one n-channel TFT 62 and a storage capacitor 64. More specifically, the gate of TFT 62 is connected to the source of TFT 44, while the drain of TFT 62 is connected to the data line. The source of TFT 62 is connected to a ground. Further, one terminal of the capacitor 64 is also connected to the gate of TFT 62. The other terminal of the capacitor 64 is grounded.

According to this arrangement, a voltage video signal from the transistor 44 is retained in the capacitor 64. TFT 62 supplies from the data line to the ground a current corresponding to the current retained in the capacitor 64.

In the example shown, a p-channel TFT 44A′ is connected in parallel to the n-channel TFT 44A which receives input of signal DSA at its gate. The gate of TFT 44A′ receives input of signal DSB. Accordingly, TFTs 44A and 44A′ turn on and off at identical timings. Similarly, a p-channel TFT 44B′ is connected in parallel to the n-channel TFT 44B which receives input of signal DSB at its gate. The gate of TFT 44B′ receives input of signal DSA. Accordingly, TFTs 44B and 44B′ turn on and off at identical timings. By providing these transistors in parallel connections in this manner, noise in written data can be eliminated. Moreover, switching performance can be enhanced, thereby increasing the range of video data voltage that can be selected.

Further, in the example shown, TFT 62 is configured by connecting two TFTs 62, 62′ (62A and 62A′, 62B and 62B′) in parallel so as to provide redundancy in the circuit. The source electrodes of the TFTs connected in parallel are connected to the ground GND via separate wiring lines. By providing these separate grounding lines in the circuit layout, fluctuations in the ground can be suppressed. It should be noted that TFT 62 may also be configured by connecting three or more TFTs in parallel, and that any desired power source, such as a negative potential, may alternatively be used in place of the ground GND. Further, when using a p-channel TFT for TFT 62, TFT 62 should be connected to PVDD instead of GND, but other than that, the above configuration may be favorably used.

It is preferable to separately generate multiple numbers of DSA and DSB so as to separately drive TFTs 44 and TFTs 48. By this separation, reliability of the operations can be enhanced.

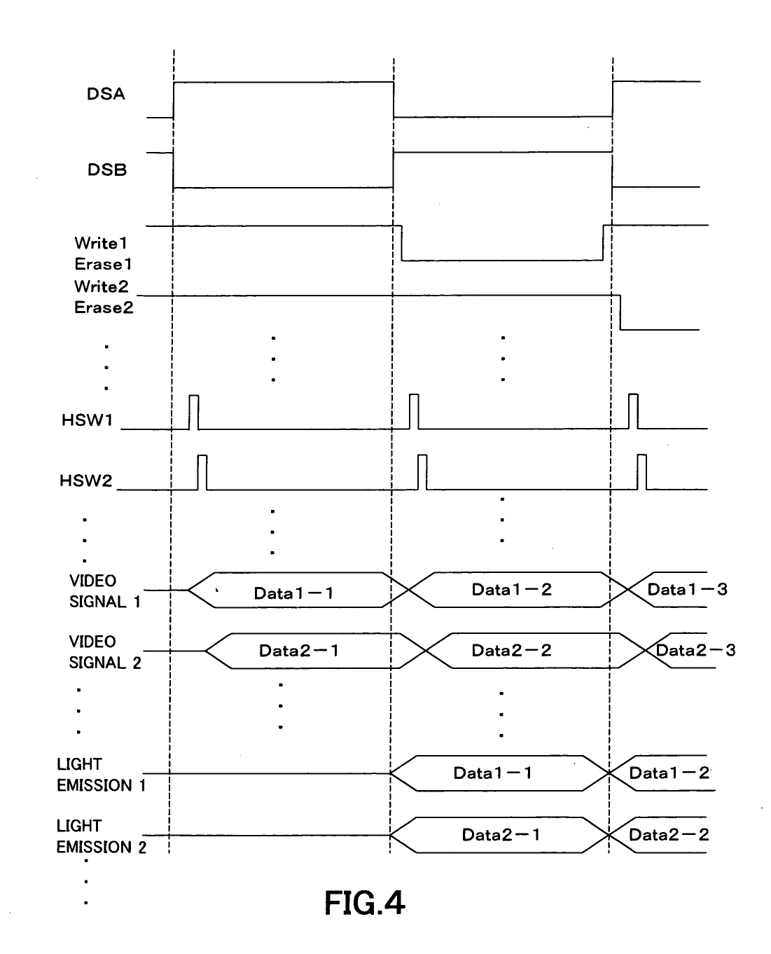

FIG. 4 is a timing chart showing operations of the circuit of FIGS. 1 and 3. DSA and DSB are complementary signals having opposite polarity which repeat H and L every horizontal period (1H). HSW1, HSW2, and so on are outputs from the horizontal shift register 40 which control the timings at which the respective video data processing circuits 46 capture video signal data. HSW1, HSW2, and so on corresponding to the respective columns sequentially output H at the point when a video signal supplies a signal for a pixel of the corresponding column. The video signal is thereby sequentially captured into the video data processing circuits 46A, 46B corresponding to the respective columns.

At the point subsequent to the capturing of the video signal into the video data processing circuit 46A, and when a video signal for the next horizontal line is being supplied, Write 1 and Erase 1 are set to L level, such that outputs from all of the video data processing circuits 46A are supplied during 1H to the respective data lines. In accordance with these outputs Data 1-1, 2-1, and soon (“1-1” denoting “column number—row number”), light emission is executed in each pixel circuit. During this operation, the video data for one line is sequentially stored in the video data processing circuit 46B. It should be noted that FIG. 4 does not show the period during which Erase alone (apart from Write) outputs L level so as to perform discharge of the auxiliary capacitor C. Erase alone is actually set to L at a timing prior to writing of data.

In the next horizontal period, Write 2 and Erase 2 are set to L level, such that outputs from all of the video data processing circuits 46A are supplied during 1H to the respective data lines. In accordance with these outputs Data 1-2, 2-2, and so on, the organic EL element OLED in each pixel circuit 50 emits light.

According to the circuit of FIGS. 1 and 3, an input video signal can be a typical video signal. By converting this video signal into a current signal, the amount of current in each current driven pixel circuit 50 can be controlled precisely.

Further, in the above-described embodiment, the conduction type of all of the TFTs in a current driven pixel circuit 50, including the drive TFT 2, is p-channel. When TFT 2 is of p-channel type, during writing of video data, the voltage-setting current Iw is drawn out from the high voltage source PVDD in the pixel to the video data processing circuit 46 via the data line. In the example of FIG. 3, an n-channel TFT is employed for TFT 62 in the video data processing circuit 46, and its source is connected to a ground. By setting the source of TFT 62 to a low potential in this manner, the voltage-setting current Iw can be precisely controlled.

Using TFTs of opposite conduction types, as described above, for the drive TFT 2 which serves as the drive element in a current driven pixel circuit 50 and the TFT 62 which serves as the output transistor in the video data processing circuit, the voltage-setting current Iw can be precisely controlled.

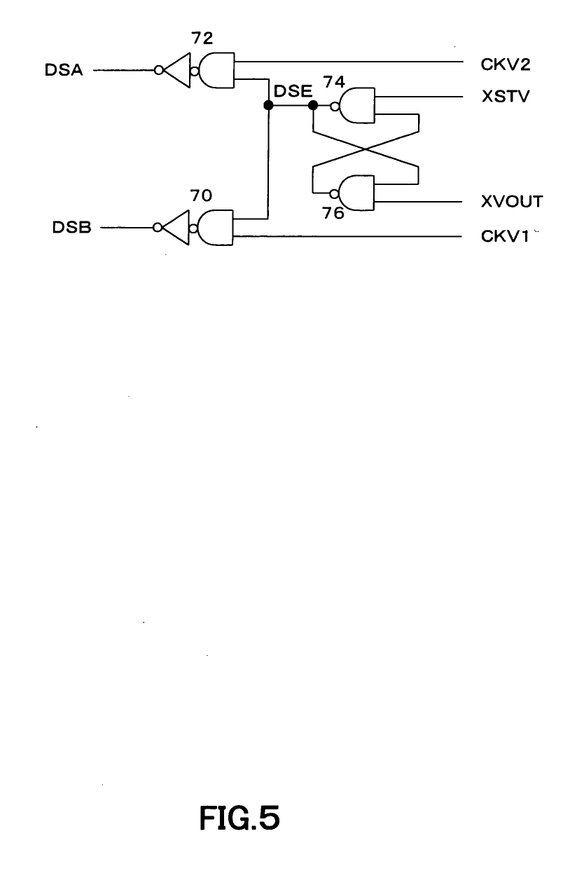

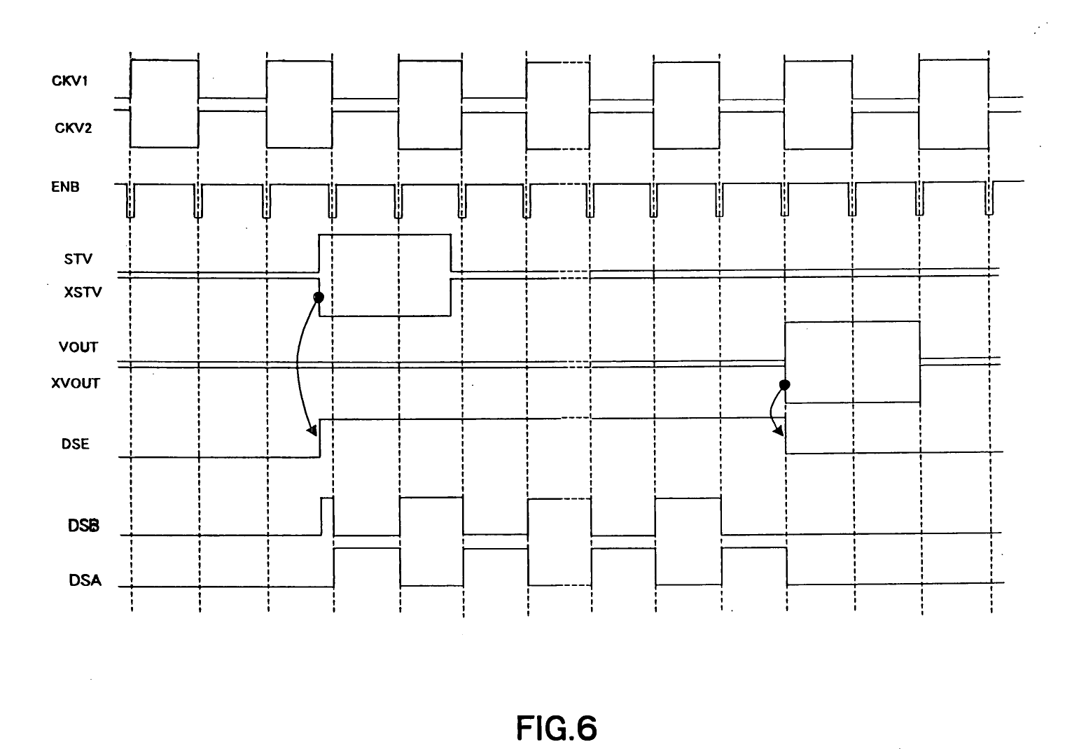

FIG. 5 shows a circuit configuration for generating signals DSA and DSB, while FIG. 6 shows waveforms of various signals in this circuit.

DSA and DSB are complementary signals having opposite polarity which repeat H and L every horizontal period. CKV1 and CKV2 are inputs into AND gates 70 and 72, respectively, and, in turn, the AND gates 70 and 72 output DSB and DSA. XSTV, which is an inverted signal of strobe signal STV indicating start of display in a vertical period, is input into NAND gate 74. XVOUT, which is an inverted signal of VOUT indicating end of display in a vertical period, is input into NAND gate 76. The output of NAND gate 74 is input into NAND gate 76, and the output of NAND gate 76 is input into NAND gate 74. The outputs from both NAND gates 74, 76 are input into AND gates 70, 72 as signal DSE. NAND gates 74, 76 have a flip-flop configuration which is set to H by L-level XSTV and reset to L by L-level XVOUT. Signal DSE therefore outputs L during the vertical blanking period from the point when VOUT becomes H to the point when STV becomes H. Because this DSE is input into AND gates 70, 72, DSB and DSA are generated as signals which maintain L level during the vertical blanking period and repeat H and L in the same manner as signals CKV1 and CKV2, respectively, only during the display period.

By locking signals DSA, DSB to L during the vertical blanking period in this manner, operation of corresponding elements is prevented, thereby achieving power saving.

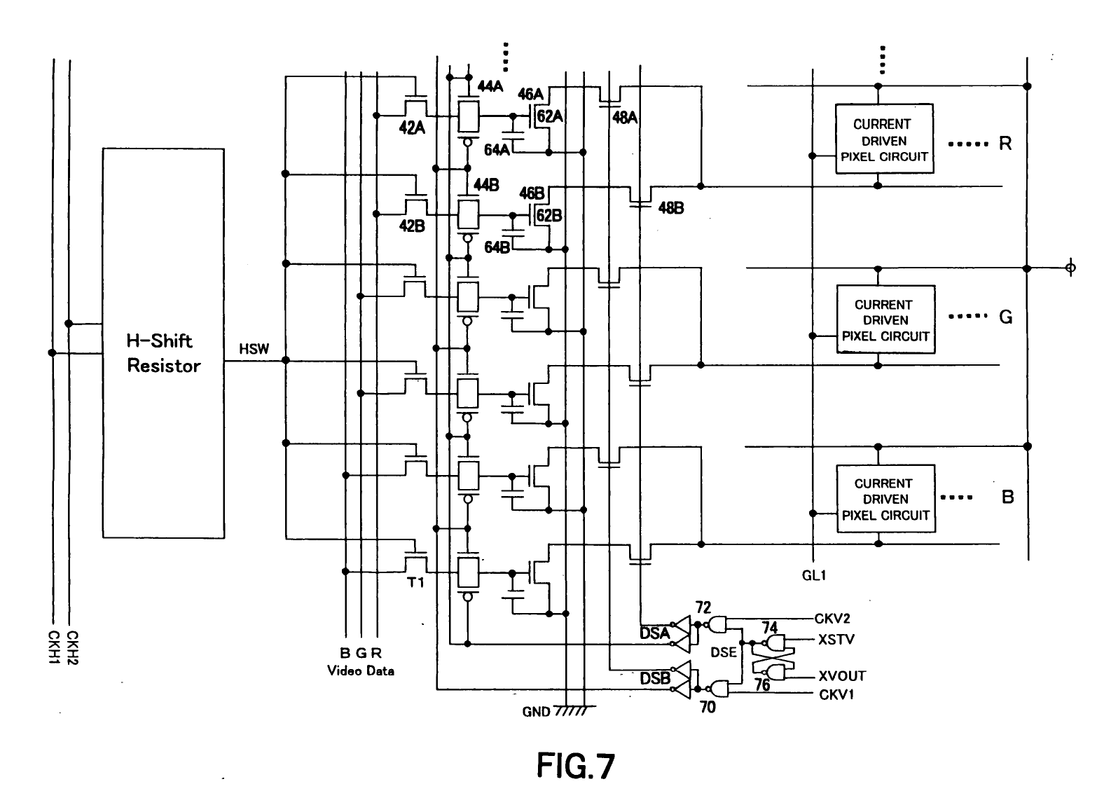

FIG. 7 shows the structures of FIGS. 3 and 5, illustrating circuit configuration for three columns. In this example, the three columns are provided corresponding to each of video signals for RGB. Full color display can be performed by providing the circuit configuration as shown for a desired number of columns.

In further detail, because three video signal lines for RGB concurrently supply signals, ON and OFF states of six TFTs 42 for the three columns of RGB are controlled by the same signal HSW. Further, two lines for connecting TFTs 62 and capacitors 64 to a ground are provided in parallel, so as to separately connect to the ground a pair of TFTs 62 and capacitors 64 provided for each column. Furthermore, each of signals DSA and DSB are generated in two separate lines. In each of the AND gates 70, 72 which may be formed by serially connecting a NAND gate and an inverter, two inverters are provided with respect to each NAND gate, thereby allowing each of DSA and DSB to be produced and supplied in separate lines to TFTs 48 and TFTs 44.

By connecting TFT 62A and TFT 62B via separate lines to the ground (power supply) GND as described above, fluctuations in the ground potential can be prevented.

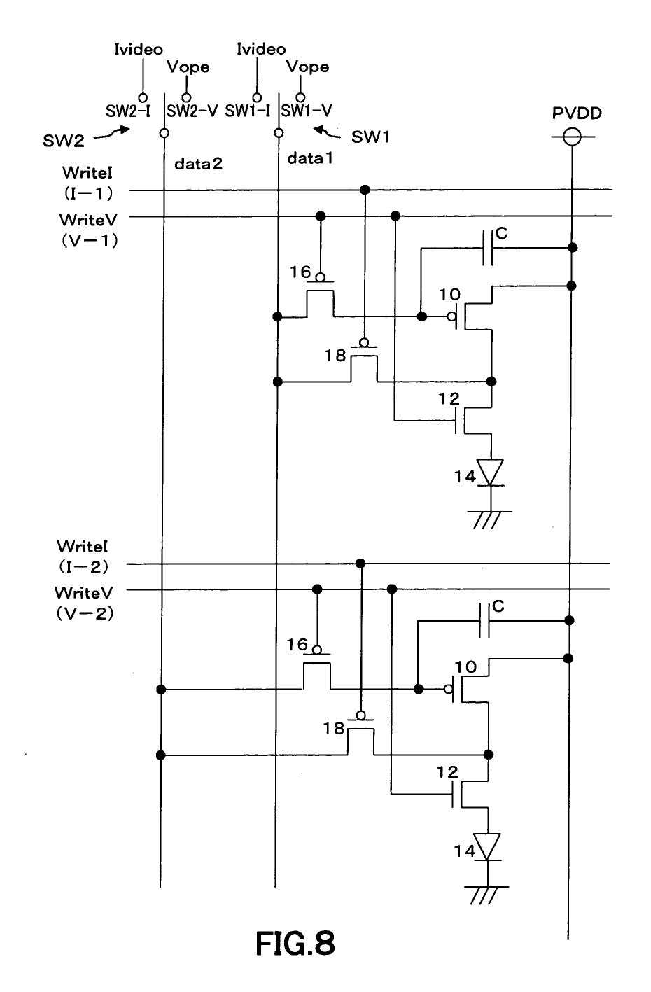

As the current driven pixel circuit 50, a circuit configuration of a direct specification type as shown in FIG. 8 may also be preferably used.

A p-channel TFT 10 has its source connected to power source PVDD and its drain connected to the anode of an organic EL element 14 via an n-channel TFT 12. The cathode of the organic EL element 14 is connected to a ground.

The gate of TFT 10 is connected to a data line (data1 or data2) via a p-channel TFT 16, and also to the power line PVDD via an auxiliary capacitor C. Further, the junction between TFT 10 and TFT 12 is connected to the data line via a p-channel TFT 18.

Write line WriteV extending in a row direction is connected to the gates of TFTs 12 and 16, while write line Write I similarly extending in a row direction is connected to the gate of TFT 18.

In the present example, first and second data lines data1 and data 2 are provided corresponding to each column. Furthermore, TFTs 16, 18 in every other row are connected to either first data line data1 or second data line data2, resulting in alternating sequential rows.

Either current video signal Ivideo or voltage operation signal Vope is supplied, in a switching manner, to each of the first and second data lines data1 and data2 via corresponding switches SW1, SW2. The current video signal Ivideo is the signal supplied to a data line in the previously described embodiment. Switch SW1 selects Ivideo when signal SW1-I is at H level and Vope when signal SW1-V is at H level. Switch SW2 selects Ivideo when signal SW2-I is at H level and Vope when signal SW2-V is at H level.

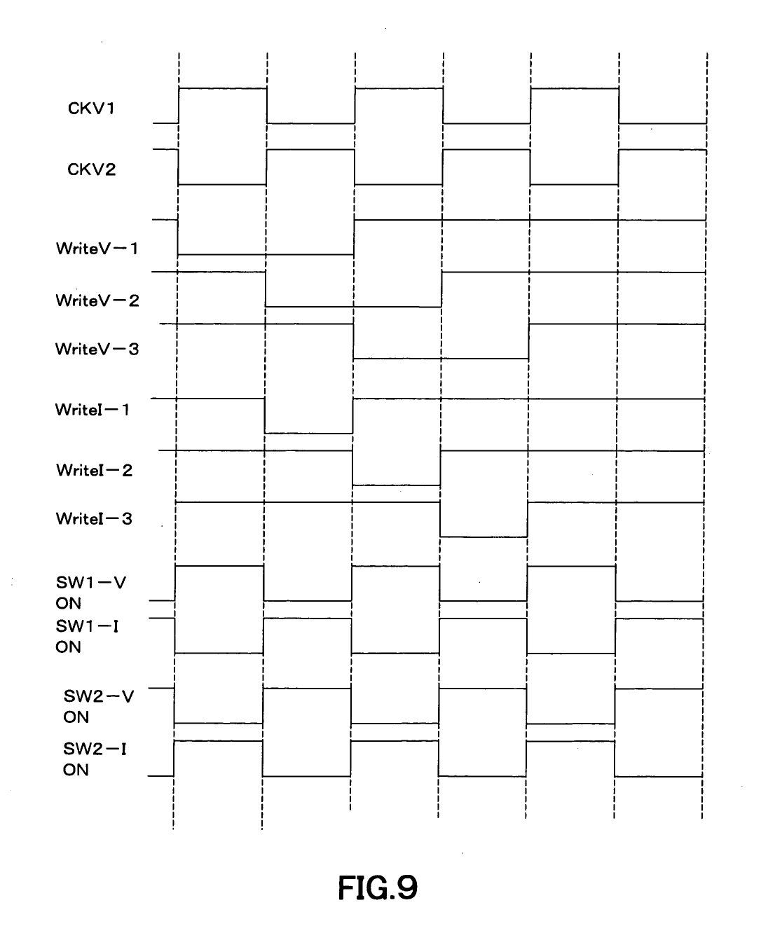

Various control clocks used in this circuit are next described referring to FIG. 9. Two clocks CKV1, CKV2 repeat H and L every 1H (one horizontal period) in a manner complementing one another, so as to control signals supplied to pixel circuits in every other row (horizontal line). In other words, during the period in which clock CKV1 is H, clock CKV2 is L, and subsequently vice versa.

Write signals Write V-1, V-2, V-3, and so on for the respective rows output L level during 2H periods at timings that are shifted by 1H in sequential rows. WriteV-1 outputs L for two clock periods from a point when CKV1 becomes H. At the timing delayed by 1H period from that point, Write V-2 outputs L, and Write V-3 outputs L after the next 1H period.

Each of write signals Write I-1, I-2, and I-3 outputs L during the latter 1H period of the L output duration of corresponding Write V-1, V-2, or V-3.

Signal SW1-V for controlling switch SW1 outputs H during the first half of the L output durations of Write V-1, V-3, V-5, and so on, thereby connecting data line data1 to Vope. Signal SW2-V outputs H during the first half of the L output durations of Write V-2, V-4, V-6, and so on, thereby connecting data line data2 to Vope.

Further, signal SW1-I for controlling switch SW1 outputs H during the L output durations of Write I-1, I-3, I-5, and so on, thereby connecting data line data1 to Ivideo. Signal SW2-I outputs H during the L output durations of Write I-2, I-4, I-6, and so on, thereby connecting data line data2 to Ivideo.

Operation of one pixel (the upper pixel in FIG. 8) according to the above-described clocks is next described.

When SW1-V is H, switch SW1 selects Vope. At that point, because Write V-1 is L and Write I-1 is H, TFT 12 and TFT 18 are turned off while TFT 16 is turned on. Vope is therefore charged in the auxiliary capacitor C, thereby setting a gate voltage of TFT 10.

Vope is a voltage value based on a luminance data (if data is separately supplied for RGB, luminance data for any one of RGB) for the corresponding pixel. When this voltage is supplied, charging of the auxiliary capacitor C is quickly completed.

Subsequently, SW1-V outputs L and SW1-I outputs H. Switch SW1 therefore selects Ivideo. Further, WriteV-1 maintains L while Write I-1 becomes L. Accordingly, TFT 18 is turned on, allowing current Ivideo to flow from power source PVDD through TFT 10 and TFT 18. The gate voltage of TFT 10 applied in this state with current Ivideo flowing in TFT 10 is written into the auxiliary capacitor C. Because the gate voltage of TFT 10 had been preliminarily set as described above by Vope, the amount of charge/discharge caused by Ivideo is small. Accordingly, even when the minimum luminance current having a small value for achieving multi-gradation display is used, the charge/discharge can be completed quickly.

Upon completion of writing of the luminance data in the above-described manner, Write V-1 and Write I-1 output H. Accordingly, TFTs 16 and 18 are turned off, while TFT 12 is turned on to supply a current from power source PVDD to the organic EL element 14. At this point, the gate voltage of TFT 10 is set to the voltage value applied when Ivideo was flowing, and this voltage is maintained by the auxiliary capacitor C. The current flowing in the organic EL element 14 therefore matches with Ivideo.

As described above, the present embodiment is of a direct specification type in which Ivideo is made to flow in TFT 10 to set its gate potential, thereby achieving precise current control Further, because the gate voltage can be set in advance using Vope, the time required for writing the luminance data can be greatly reduced, allowing easy adaptation to multi-gradation display.

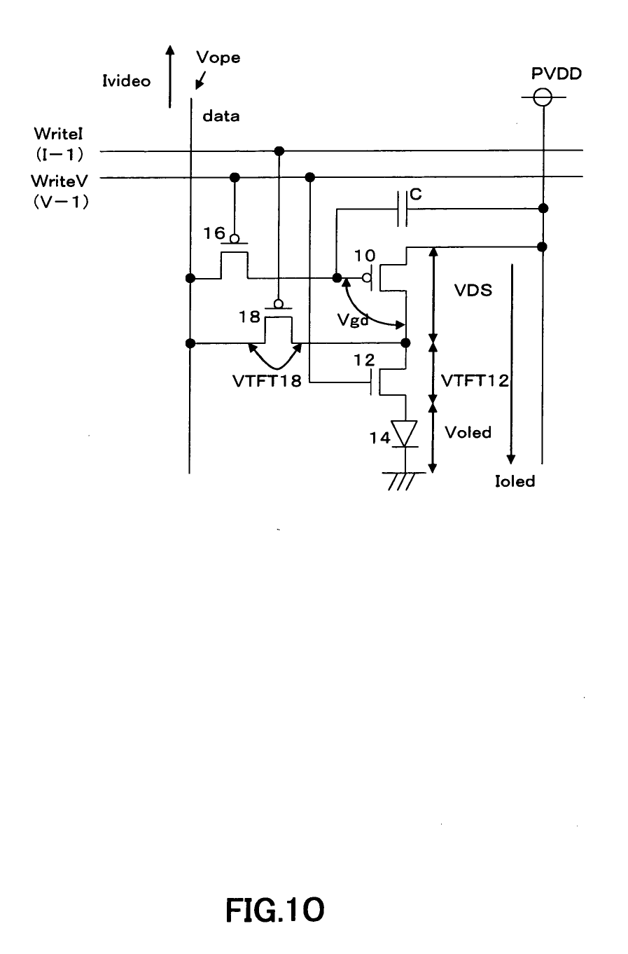

The input voltage Vope is next explained referring to FIG. 10. Voltage Vope is not a voltage which directly indicates a video information, but voltage information which provides the operating point of TFT 10 for allowing current signal Ioled, which corresponds to the luminance information, to flow in the organic EL element 14. In other words, Ivideo supplied in the data line corresponding to the luminance information should be substantially equivalent to current Ioled supplied to the organic EL element 14 (Ivideo≈Ioled). During when TFTs 10 and 18 are turned on to allow Ivideo to flow, Vope should equal to a value obtained by subtracting the ON resistance of these TFTs from PVDD, i.e., Vope=PVDD−(VDS+VTFT18). Further, during when current Ioled is made to flow in the organic EL element 14, Vope should equal to a value obtained by adding the ON resistance VTFT12 of TFT 12, the ON resistance Voled of the organic EL element 14, and the potential Vgd between the gate and source of TFT 10, i.e., Vope=Voled+VTFT12+Vgd.

Vope can thus be determined. Because the element characteristic is known in advance, Vope in accordance with a luminance signal can be calculated. When designing a pixel, a curve for converting input luminance signal into Vope may be determined in advance by simulation. A circuit which performs conversion based on this curve can then be provided, and the output from this circuit can be employed as Vope.

In the present embodiment, data line data2 is provided in parallel to data line data1. The pixels in the vertical direction are alternately connected to data lines data1 and data2. At timings that are shifted by 1H of clock CKV1, writing of Vope and writing of Ivideo are sequentially performed in the respective pixels. As a result, the start timings of light emission by the organic EL elements in the respective pixels in the column are sequentially shifted by 1H. Data line data1 writes data during 2H into a pixel in the first line, then into a pixel in the third line during the next 2H, and continues to perform the writing sequentially in pixels in odd rows. Data line data2 writes data during 2H into a pixel in the second line, then into a pixel in the fourth line during the next 2H, and continues to perform the writing sequentially in pixels in even rows. The writing of data into the second line is delayed by 1H with respect to the writing of data into the first line. As such, from the pixel in the first line downward, writing is sequentially started every 1H. 1H is required for writing Vope, and 1H is required for writing Ivideo, thereby requiring in total two clocks for writing data into one pixel. However, the time required for writing data into one column is equivalent to a case in which data is written using 1H in every line.

While the above explanation refers to only one column of pixels, in actual practice, the voltage (Vope) writing is sequentially performed for all pixels in one line during 1H period, and, during the next 1H period, the current (Ivideo) writing is performed in all those pixels in the one line. During the period in which the current writing is perform for one line, the voltage writing is concurrently performed in the next line.

More specifically, the voltage writing is performed in a dot sequential format in which Vope for all pixels in one line is sequentially supplied into data1 or data2 during 1H period. In contrast, the current writing is performed in a line sequential format in which Ivideo for all pixels in one line is supplied in a batch into data1 or data2 during 1H period.

The current writing may alternatively be performed in a block sequential format by dividing pixels in one line into a plurality of blocks and supplying Ivideo for each of those blocks in one batch into data1 or data2. In this case, the number N of blocks may be determined by dividing 1H period by the current writing time. For example, assuming that the current writing time is tw, N=1H/tw. In this manner, the current writing can be reliably completed.

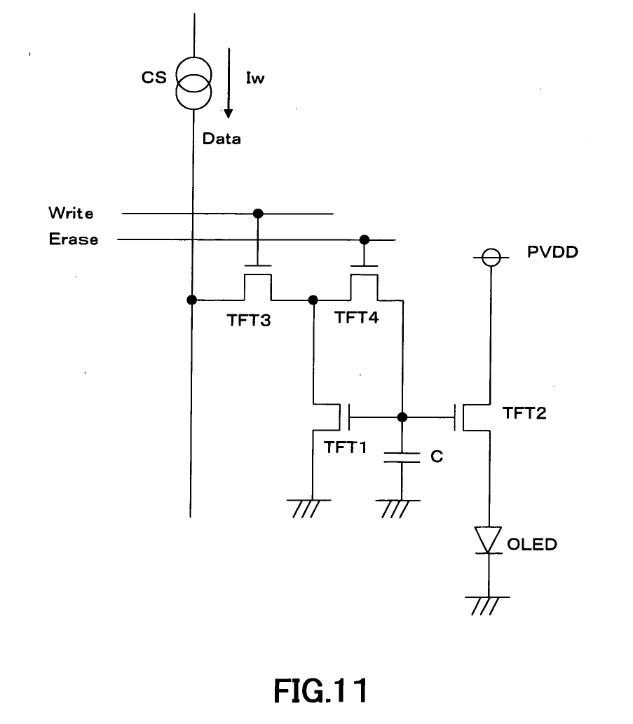

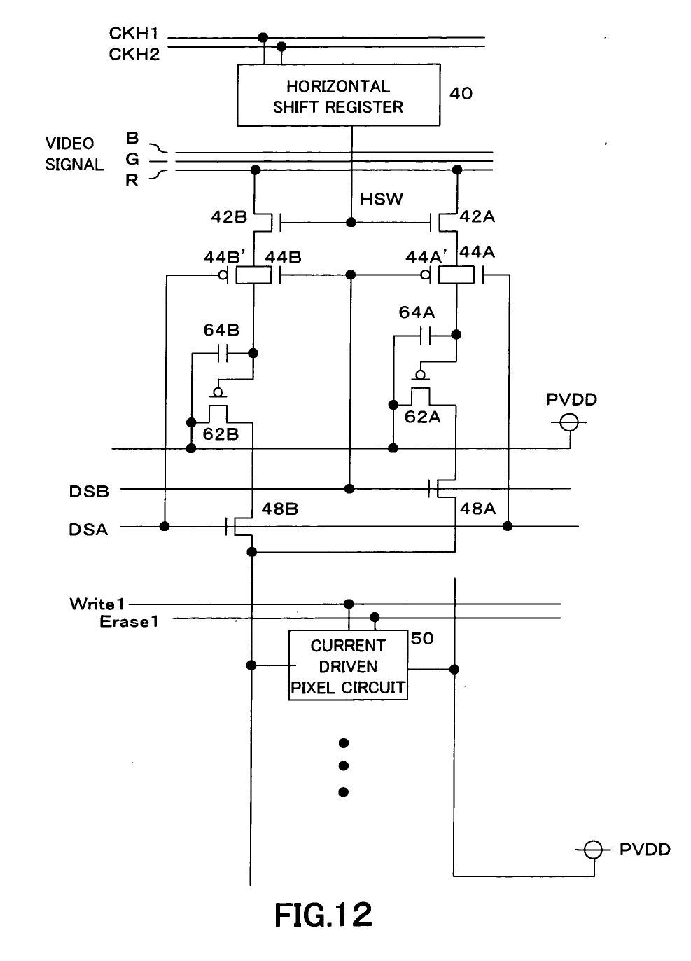

FIGS. 11 and 12 show a configuration according to another embodiment. The structures of FIGS. 11 and 12 correspond to those of FIGS. 2 and 3, respectively.

FIG. 11 shows a configuration of the current driven pixel circuit 50 according to the present embodiment. As shown, n-channel TFTs are employed for TFTs 1, 2, 3, and 4.

One terminal of TFT 3 is connected to data line Data which supplies data current Iw from current source CS. The other terminal of TFT 3 is connected to one terminal of TFT 1 and one terminal of TFT 4. TFT 1 has the other terminal connected to a ground, and the gate connected to the gate of p-channel TFT 2 for driving an organic EL element OLED. TFT 4 has the other terminal connected to the gates of TFT 1 and TFT 2. The gates of TFT 1 and TFT 2 are connected to a ground via an auxiliary capacitor C. The gate of TFT 4 is connected to gate line Erase.

When writing data, H level signals are supplied in gate lines Write and Erase, thereby turning on TFTs 3 and 4. As a result, current Iw flows from current source CS to the ground via TFTs 3 and 1. At this point, because TFT4 is ON and TFTs 1 and 2 constitute a current mirror, a current corresponding to current Iw similarly flows in TFT 2. The gate voltage of TFT 1 applied in this state is retained in the auxiliary capacitor C. Until Erase is again set to H, a drive current continues to flow in OLED via TFT 2.

When n-channel TFTs are employed as described above, the direction of current in the video processing circuit 46, which corresponds to current source CS, must also be reversed. Accordingly, as shown in FIG. 12, p-channel TFTs are employed for TFTs 62A, 62B, and their sources are connected to power source PVDD. Using this arrangement, a video signal is retained in capacitors 64A, 64B, and a current in accordance with the retained voltage is made to flow in TFTs 62A, 62B and supplied to the data line.

In the present embodiment, the conduction type of all of the TFTs in a current driven pixel circuit 50, including the drive TFT2, is n-channel. When TFT2 is of n-channel type, during writing of video data, the voltage-setting current Iw is supplied from the video data processing circuit 46 to the current driven pixel circuit 50 via the data line. A p-channel TFT is therefore employed for TFT 62 in the video data processing circuit 46, and its source is connected to power source PVDD. By setting the source of TFT 62 to a high potential in this manner, the voltage-setting current Iw can be precisely controlled.

When TFTs of opposite conduction types are used, as described above, for the drive TFT 2 which serves as the drive element in a current driven pixel circuit 50 and the TFT 62 which serves as the output transistor in the video data processing circuit, the voltage-setting current Iw can be precisely controlled.

What is claimed is:

1. A display device for performing display including an emissive element in each of pixels arranged in a matrix, comprising:
a voltage-to-current conversion circuit for converting an externally supplied voltage video signal indicating a display luminance for each pixel into a current video signal;
a data line connected to the voltage-to-current conversion circuit for sequentially receiving therefrom the current video signal for pixels along a vertical direction; and
a pixel circuit connected to the data line, in which a voltage in accordance with the current video signal supplied in the data line is retained in an auxiliary capacitor, and a current corresponding to the voltage retained in the auxiliary capacitor is made to flow in a drive element, so as to cause light emission in a corresponding emissive element.

2. A device as defined in claim 1, wherein
the voltage-to-current conversion circuit includes at least two pairs of retaining circuit and output circuit, each pair comprising:
a retaining circuit for retaining a voltage in accordance with the voltage video signal for one horizontal line; and
an output circuit for supplying to a corresponding data line a current in accordance with the voltage for one horizontal line retained in the paired retaining circuit; wherein
when the voltage video signal is being written into a retaining circuit of one of the pairs, a current is output from an output circuit of the other of the pairs, and this process is repeated by sequentially alternating between the pairs so as to perform line sequential display.

3. A device as defined in claim 1, wherein the voltage-to-current conversion circuit comprises:
an output transistor which receives the voltage video signal at its control terminal and outputs to the data line a current in accordance with the voltage video signal.

4. A device as defined in claim 3, wherein the voltage-to-current conversion circuit further comprises:
a capacitor for retaining the voltage video signal supplied to the control terminal of the output transistor.

5. A device as defined in claim 3, wherein
the drive element in the pixel circuit is a transistor, and the drive element and the output transistor of the voltage-to-current conversion circuit are of opposite conduction types.

6. A device as defined in claim 1, wherein the voltage-to-current conversion circuit comprises:
a capacitor for retaining a voltage in accordance with the voltage video signal; and
an output transistor for outputting a current in accordance with the voltage retained in the capacitor.

7. A device as defined in claim 6, wherein the voltage-to-current conversion circuit comprises:
first and second capacitors each for retaining a voltage in accordance with the voltage video signal;
first and second output transistors for outputting a current in accordance with the voltage retained in the first and second capacitors, respectively;
an input switching circuit for controlling switching of input of the voltage video signal into the first and second capacitors; and
an output switching circuit for controlling switching of output of the current to the data line from the first and second output transistors.

8. A device as defined in claim 7, wherein
each of the first and second output transistors receives at its control terminal a charge voltage of the corresponding one of first or second capacitors, has one controlled terminal connected to a power source; and one other controlled terminal connected to the data line.

9. A device as defined in claim 8, wherein
while the voltage video signal is supplied by the input switching circuit to the first capacitor, the output switching circuit supplies the current from the second output transistor to the data line, and
while the voltage video signal is supplied by the input switching circuit to the second capacitor, the output switching circuit supplies the current from the first output transistor to the data line.

10. A device as defined in claim 9, wherein the first and second output transistors are connected to the power source via separate lines.
